(19) United States
(12) Patent Application Publication
(10) Pub. No.: US 2013/0305541 A1
(43) Pub. Date: Nov. 21, 2013

(54) Split Spring Locking Feature for a Folding Tool

(71) Applicant: Tom D. Koenig, Lakewood, CO (US)

(72) Inventor: Tom D. Koenig, Lakewood, CO (US)

(73) Assignee: SPYDERCO, INC., Golden, CO (US)

(21) Appl. No.: 13/474,396

(22) Filed: May 17, 2012

(51) Int. Cl. B26B 1/04; B26B 1/06

(52) U.S. Cl. 30/161; 30/164

(57) ABSTRACT

A folding tool with improved locking features is provided. The locking feature comprises a substantially rigid member disposed between or proximal to a handle portion of the tool. The substantially rigid member comprises a bifurcated end forming at least one biased member for contacting a tang of the tool and securing the tool in at least one of a closed and an open position with additional locking features.

### FIELD OF THE INVENTION

The present invention relates generally to folding tools. More specifically, the present invention relates to folding tools, including knives, with an improved locking feature comprising a biased element in communication with a folding portion of the tool for selectively securing the folding portion in at least an open position.

### BACKGROUND

Common mechanisms known for securing tools and/or knives in an open or closed position include various locking features. Locking features include back locks and liner locks, for example. Known locking mechanisms secure the blade in an open or closed position until a feature of the lock is activated or released and the blade folded to a closed or open position. Inadvertent closure or opening without a locking mechanism can expose the cutting edge of the blade and the likelihood of injury to a user or bystander.

As used herein, the term “folding tool” or “folding knife” may be used interchangeably, since the locking feature can be implemented with either a folding tool or knife assembly. It will be expressly recognized that features of the present disclosure are not limited to knives, even where discussion of specific embodiments pertains to knives.

In various jurisdictions, however, mechanisms that render a knife a “locking knife” prevent or call into question the legal propriety of an individual's possession of such knives. At the same time, however, folding knives provide a broad range of conveniences and utility to users. The history of folding knives is believed to trace back thousands of years. The appeal of such tools and demand for the same is unlikely to be impacted by regulations and statutes. Accordingly, there exists a long-felt and unsolved need to provide a folding knife with blade securing features which enable a knife to conform with various laws and regulations yet still provides the desired safety, convenience, and functional advantages of a folding knife.

### SUMMARY OF THE INVENTION

Accordingly, the present invention contemplates novel systems, devices, and methods for securing a folding knife in an open or closed position without the use of conventional locking features such as known back locks, liner locks, etc.

The Summary of the Invention is neither intended nor should it be construed as being representative of the full extent and scope of the present disclosure. The present disclosure is set forth in various levels of detail in the Summary of the Invention as well as in the attached drawings and the Detailed Description of the Invention and no limitation as to the scope of the present disclosure is intended by either the inclusion or non-inclusion of elements, components, etc. in this Summary of the Invention. Additional aspects of the present disclosure will become more readily apparent from the Detailed Description, particularly when taken together with the drawings.

Various laws and regulations governing the production, sale and possession of folding knives forbid or limit the use of certain locking features perceived to render a knife the functional equivalent of a fixed blade knife. The production and use of a folding knife without any blade retention means, however, produces a potentially dangerous product. Accordingly, it is an object of the present invention to provide a folding knife which does not comprise the use of conventional locking features, such as lock-back, back-lock, liner-lock, frame lock, or mid lock features yet still allows the knife to be securely held in one of an open or closed position.

It is yet another object of the present invention to provide a folding knife devoid of conventional locking means that is both efficient and economical to produce. It is a further still object of the present invention to provide such a tool that is also lightweight and user-friendly.

It is yet another object of the present invention to provide a folding knife feature devoid of conventional locking features and which provides visual, aural, or tactile feedback to a user that the knife blade is in a fully open or fully closed position.

Accordingly, in various embodiments, the present invention comprises a folding knife with a split backspring mechanism disposed between the scales. The split backspring is in communication with the tang of the blade, wherein the tang comprises a cut out feature for receiving at least a portion of the split backspring and stabilizing or securing the blade in at least an open position. Although the present drawings and claims describe a device to retain a blade in an open or extended position it should be appreciated that the same concept and novel design could be used to retain a folding knife blade in a closed position. For the purposes of the present disclosure, it should be recognized that the terms “stabilizing” or “securing” and “stable” or “secure” or “retain” or “retention” generally refer to an aspect of the present invention whereby a knife blade is placed in an open or closed position through the application of a first force, and wherein a second force is required to displace the knife blade from the open position, the second force being larger than the first force.

In one embodiment, a folding knife is provided comprising a blade rotatable about an axis. At least a portion of the blade is disposed between a pair of scales in both an open and closed position. The axis of rotation of the blade passes through a portion of a tang of the blade, the axis being generally perpendicular to the direction in which the blade extends. The tang comprises a generally arcuate portion that is convex about the axis of rotation and a notch feature for receiving securing means of the knife. Securing means, in various embodiments, comprise a biased feature for securing the blade at least in an open position (i.e. a position of use).

In various embodiments, securing or blade retention means of the present invention comprise a split backspring feature disposed between the scales of the knife. In one embodiment, the split backspring comprises a single piece of material with a forked or split distal end proximate the tang such that when the blade is rotated to an open position, a biased portion of the split backspring engages the notch feature of the tang such that the blade is held in a substantially secure position, but may be released and returned to a closed position without the use or release of conventional locking features.

In various embodiments, tools of the present invention comprise a split backspring locking feature wherein the locking feature biases the knife blade toward a closed position in at least an initial range of rotation. In one embodiment, the blade is biased toward a closed position when the blade is between a closed position corresponding to zero degrees of rotation and a second position comprising an initial degree of rotation. A tool of the present invention thus comprises a blade and a biasing element such that the blade is biased toward a closed position throughout approximately the initial 30 degrees of blade rotation (with respect to a closed position), such that the blade will return to a completely closed position when positioned between 0 and approximately 30 degrees of rotation, absent sufficient external forces.

These and other advantages will be apparent from the disclosure of the invention(s) contained herein. The above-described embodiments, objectives, and configurations are neither complete nor exhaustive. As will be appreciated, other embodiments of the invention are possible using, alone or in combination, one or more of the features set forth above or described in detail below. Further, the summary of the invention is neither intended nor should it be construed as being representative of the full extent and scope of the present invention. The present invention is set forth in various levels of detail in the summary of the invention, as well as, in the attached drawings and the detailed description of the invention and no limitation as to the scope of the present invention is intended to either the inclusion or non-inclusion of elements, components, etc. in this summary of the invention. Additional aspects of the present invention will become more readily apparent from the detailed description, particularly when taken together with the drawings.

### BRIEF DESCRIPTION OF THE DRAWINGS

Those of skill in the art will recognize that the following description is merely illustrative of the principles of the disclosure, which may be applied in various ways to provide many different alternative embodiments. This description is made for illustrating the general principles of the teachings of this disclosure invention and is not meant to limit the inventive concepts disclosed herein.

The accompanying drawings, which are incorporated in and constitute a part of the specification, illustrate embodiments of the disclosure and together with the general description of the disclosure given above and the detailed description of the drawings given below, serve to explain the principles of the disclosures.

FIG. 1 is a front elevation view of a folding knife according to one embodiment of the present invention in an open position;

FIG. 2 is a front elevation view of a folding knife according to one embodiment of the present invention in a closed position;

FIG. 3 is a front elevation view of a locking feature according to one embodiment of the present invention;

FIG. 4 is a front elevation view of a folding knife blade according to one embodiment of the present invention;

FIG. 5 is an exploded perspective view of a folding knife according to one embodiment of the present invention;

It should be understood that the drawings are not necessarily to scale. In certain instances, details that are not necessary for an understanding of the disclosure or that render other details difficult to perceive may have been omitted. It should be understood, of course, that the disclosure is not necessarily limited to the particular embodiments illustrated herein.

To assist in the understanding of one embodiment of the present invention the following list of components and associated numbering found in the drawings is provided herein:

| # | Component |
|---|---|
| 2 | Tool |
| 4 | Blade |
| 6 | Handle |
| 8 | Scale |
| 10 | Locking feature |
| 12 | Biased member |
| 14 | Anvil |
| 16 | Tang |
| 18 | Notch |
| 20 | Shelf portion |
| 22 | Body portion |
| 26a, 26b | Apertures |
| 32 | Through hole |
| 34 | Tipping point |
| 36 | Secondary notch |
| R | Radius |

### DETAILED DESCRIPTION

The present invention has significant benefits across a broad spectrum of endeavors. It is the applicant's intent that this specification and the claims appended hereto be accorded a breadth in keeping with the scope and spirit of the invention being disclosed despite what might appear to be limiting language imposed by the requirements of referring to the specific examples disclosed. To acquaint persons skilled in the pertinent arts most closely related to the present invention, a preferred embodiment of the method that illustrates the best mode now contemplated for putting the invention into practice is described herein by, and with reference to, the annexed drawings that form a part of the specification. The exemplary method is described in detail without attempting to describe all of the various forms and modifications in which the invention might be embodied. As such, the embodiments described herein are illustrative, and as will become apparent to those skilled in the arts, can be modified in numerous ways within the scope and spirit of the invention, the invention being measured by the appended claims and not by the details of the specification.

Although the following text sets forth a detailed description of numerous different embodiments, it should be understood that the legal scope of the description is defined by the words of the claims set forth at the end of this disclosure. The detailed description is to be construed as exemplary only and does not describe every possible embodiment since describing every possible embodiment would be impractical, if not impossible. Numerous alternative embodiments could be implemented, using either current technology or technology developed after the filing date of this patent, which would still fall within the scope of the claims.

To the extent that any term recited in the claims at the end of this patent is referred to in this patent in a manner consistent with a single meaning, that is done for sake of clarity only so as to not confuse the reader, and it is not intended that such claim term by limited, by implication or otherwise, to that single meaning Finally, unless a claim element is defined by reciting the word “means” and a function without the recital of any structure, it is not intended that the scope of any claim element be interpreted based on the application of 35 U.S.C. §112, sixth paragraph.

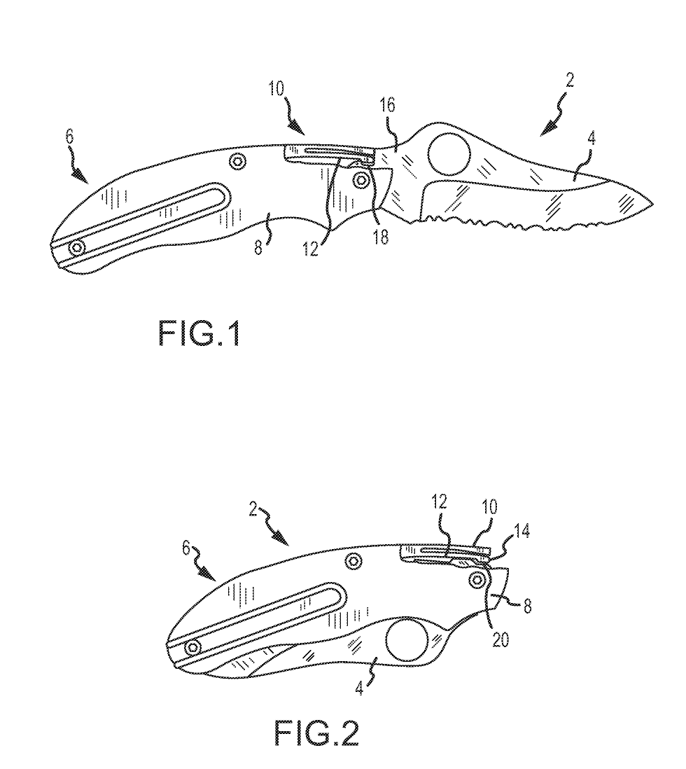

Referring now to FIGS. 1-5, a folding knife according to various embodiments of the present invention is shown. It should be understood that the drawings are not necessarily to scale. In certain instances, details that are not necessary for an understanding of the invention or that render other details difficult to perceive may have been omitted from these drawings. It should be understood, of course, that the invention is not limited to the particular embodiments illustrated in the drawings.

FIG. 1 is a front elevation of a folding knife according to one embodiment shown in the open position. The folding knife 2 generally comprises a blade portion 4, a handle 6 comprising at least one scale 8. The blade 4 is hingedly attached to the handle 6 such that the blade 4 may be selectively rotated between an open and closed position. A portion of the scale 8 has been removed in FIG. 1 to show an internal locking feature 10. Internal locking feature 10 comprises a split backspring with at least one biased member 12 for securing a blade 4 in at least one of an open and a closed position.

The biased member 12 generally comprises a distal end having an anvil 14 adapted to communicate with a tang portion 16 of the blade 4. The tang 16 receives the biased member 12 when the blade is rotated to a fully-open position such that the blade 4 is in a secured state. As used herein, locked or secured refers generally to a state wherein the blade requires a greater force or moment to move to rotate the blade out of the “secured” state than needed to place the blade in that state. In various preferred embodiments, “secured” or “locked” does not imply or require the use of an additional locking or release feature.

In a preferred embodiment, the anvil 14 provided on a distal end of the biased member 12 is received by a notch 18 provided in the tang 16 of the blade 4. As shown in FIG. 1, the anvil 14 is biased toward a position where it is engaged with the notch 18 and thus secures the blade in an open position without the need to activate release or latch mechanisms in order to return the blade to a closed position. In order to close the blade 4 shown in FIG. 1, a rotational force may be imparted upon the blade, the force being greater than a rotational force required to secure the blade in the open position.

FIG. 2 is a front elevation view of a folding knife 2 according to one embodiment provided in a closed position. A portion of a scale 8 is removed in FIG. 2 for illustration purposes in order to show a locking feature 10 according to one embodiment. The biased member 12 of the locking feature 10 communicates with the tang 16 of the blade 4 when the blade is in a closed position such that the blade 4 is biased toward the closed position. As further discussed herein, the tang 16 of the blade 4 is provided with a preferred geometry such that the anvil 14 communicates with the tang 16 and the blade is biased toward a closed position when the blade is disposed at angle of between approximately 0 and 30 degrees. The tang 16 is provided with a shelf portion 20 such that when the blade 4 is disposed in a closed position, the biased member 12 and anvil 14 will provide a resistance force to an opening motion, at least through a preliminary or initial rotation of the blade 4.

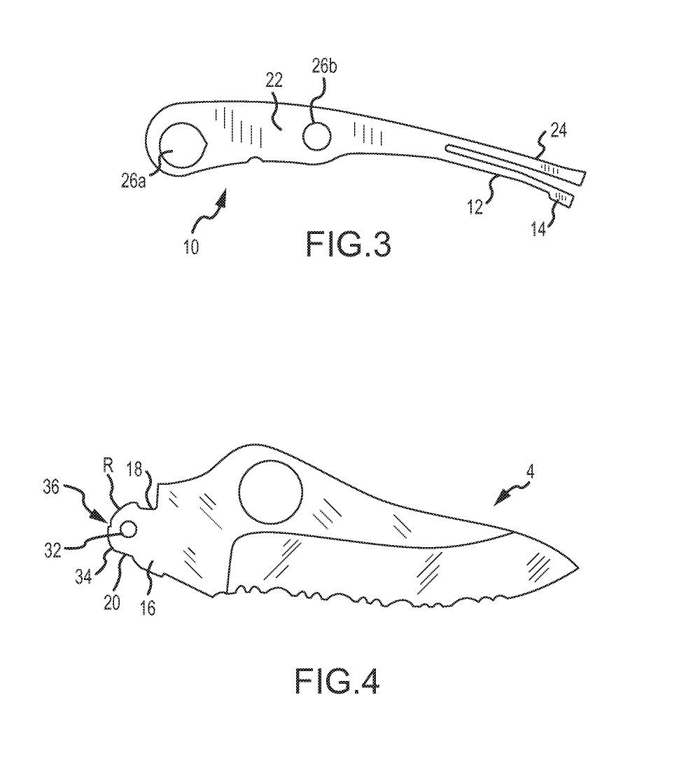

FIG. 3 is a front elevation view of a locking feature 10 according to one embodiment. As shown, the locking feature 10 comprises a main body portion 22 extending toward a bifurcated portion comprising a biased member 12 and rigid portion 24. A distal end of the biased member 12 comprises an anvil 14. One or more apertures 26a, 26b are provided in the locking feature 10 for securing the locking feature 10 to additional components. For example, in one embodiment, a locking feature is disposed between two scales of a knife handle, with at least one fastener provided through at least one aperture 26.

In alternative embodiments, a biased member is provided as an extension from the main body portion and the locking member is devoid of an upper rigid portion. For example, in one alternative embodiment, a locking member is provided having a main body portion that is substantially rigid. The main body portion is secured to a handle portion of a knife and the main body portion further comprises a tapered distal end, such that at least the end of the locking member proximal to the tang extends in a tapered manner and comprises a biased member. Thus, in various embodiments, a single biased protrusion extends from the main body portion as opposed to alternative embodiments wherein the biased member and the rigid portion extend from the main body portion and are at least partially separated by an elongate recess.

FIG. 4 is a front elevation view of a knife blade 4 adapted for use with a locking feature 10 according to various embodiments of the present invention. A blade 4 with a tang portion 16 is provided, the tang 16 comprising a notch 18, a radius of curvature R, a shelf portion 20, and a through hole 32 for rotatably mounting the knife with respect to a handle portion. The notch 18 provides for a point of engagement between an anvil of a locking member and assists in securing the blade in an open position. A radius R extends from one end of the notch 18 and enables rotation of the blade 4 even when contacted by the anvil of the locking member. In one embodiment, the radius R comprises a radius of between approximately 0.10 inches and 0.50 inches. In a preferred embodiment, the radius R comprises a radius of between approximately 0.15 inches and 0.25 inches. In a more preferred embodiment, the radius R comprises a radius of approximately 0.20 to 0.22 inches, particularly 0.2173 inches.

A shelf member 20 is provided adjacent the radius of curvature R and opposite the notch 18. The shelf member 20 communicates with the anvil of the locking member when the blade is in a substantially closed position and allows the anvil 14 and biased member 12 to bias the blade toward a completely closed position when the blade is disposed in a rotational position between zero and approximately 30 degrees, where zero degrees corresponds to a completely closed position. Accordingly, the intersection of the shelf member 20 and the radius R comprises a tipping point 34, wherein when the blade is rotated such that the anvil 14 comes into contact with the radius R and is no longer in contact with the shelf member 20.

In one embodiment, a secondary notch 36 is provided along the radius of curvature R. Secondary notch 36 provides feedback and/or physical indication of the partial rotation of the blade 4. In one embodiment, the secondary notch 36 is provided at approximately the mid-point of the radius R such that a user is alerted to the rotational position of the blade 4. In various embodiments, locking members 10 of the present invention are provided without secondary features such as back locks, liner locks, and various other known system for securing a blade of a folding knife as shown and described herein. As an additional safety measure, a secondary notch 36 is provided to indicate, such as through tactile feedback, that the blade is partially closed and/or provide temporary restraint of the blade in that position.

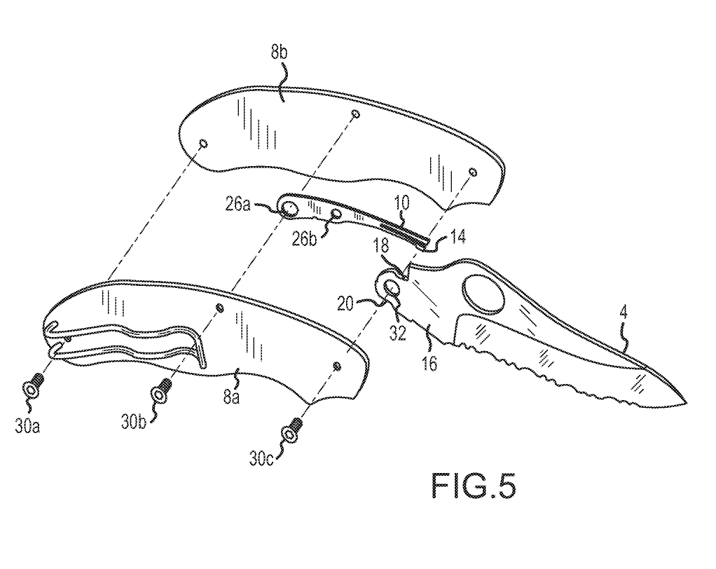

FIG. 5 is an exploded perspective view of a folding knife 2 according to one embodiment of the present invention. As shown, a knife blade 4 may be rotatably disposed between two scales 8a, 8b of a handle portion. The scales 8a, 8b and blade may be secured by one or more fasteners 30a, 30b, 30c, wherein at least one fastener is provided through a non-threaded through hole 32 provided in the tang 16 of the blade. Locking member 10 is disposed between scales 8a, 8b and secured by at least one fastener 30b. The locking member 10 is disposed proximal to the top edge of the handle portion and proximal to the tang portion 16 of the blade 4. While various embodiments of the present invention contemplate various features, such as the locking member 10 and scales 8a, 8b being secured to each other and/or various additional features of the present invention, it will be expressly recognized that the present invention is not limited to any particular system or means for securing elements. Indeed, it is contemplated that various members and portions of various members may be assembled and/or secured through various means and devices, including adhesives, welding, ultrasonic welding, and various other devices and systems as will be recognized by one of skill in the art.

While various embodiments of the present invention have been described in detail, it is apparent that modifications and alterations of those embodiments will occur to those skilled in the art. However, it is to be expressly understood that such modifications and alterations are within the scope and spirit of the present invention, as set forth in the following claims. Further, the invention(s) described herein are capable of other embodiments and of being practiced or of being carried out in various ways. In addition, it is to be understood that the phraseology and terminology used herein is for the purposes of description and should not be regarded as limiting. The use of “including,” “comprising,” or “adding” and variations thereof herein are meant to encompass the items listed thereafter and equivalents thereof, as well as, additional items.

What is claimed is:

1. A folding tool comprising:
an implement having an upper edge, a lower edge, a tang and a distal end;
a handle portion comprising a forward end, a rear end, an upper end and a lower end;
said tang of said implement rotatably interconnected to said handle portion;
a locking member interconnected to said forward end of said handle portion, said locking member comprising an upper arm and a deflectable lower arm separated by a predetermined distance, and wherein the deflectable lower arm is in contact with said tang to provide a biasing force on said implement.

2. The folding tool of claim 1, wherein said locking member upper arm is a substantially rigid portion and said lower arm is a biased portion separated by an elongate recess.

3. The folding tool of claim 1, wherein said tang comprises a notch portion, said notch portion adapted to receive at least a portion of said biased member such that a closing action of said implement requires a greater force than an opening action.

4. The folding tool of claim 1, wherein said biased portion biases said implement toward a closed position at least when said implement is disposed between approximately zero degrees of rotation of approximately 30 degrees of rotation from said closed position.

5. The folding tool of claim 1, wherein said biased portion comprises an extension of said substantially rigid portion.

6. The folding tool of claim 1, wherein said substantially rigid portion comprises a bifurcated end portion, at least one of said bifurcated portions forming said biased member.

7. The folding tool of claim 1, wherein a distal end of said lower arm comprises an anvil for communicating with said tang portion.

8. The folding tool of claim 1, wherein said tang portion comprises a radius of curvature for communicating with said lower arm throughout rotation of said blade.

9. The folding tool of claim 1, wherein said locking member is positioned between a first scale and a second scale of said handle.

10. The folding tool of claim 1, wherein said implement comprises a knife blade.

11. A locking member for a folding knife comprising:
a main body portion having a first end and a second end defining length, and a width, said length being substantially greater than said width;
at least one aperture for securing said locking member to a handle portion of said folding knife;
said second end of said main body portion comprising an elongate recess provided between an upper portion and a lower portion, said lower portion comprising a biased member and said upper portion comprising a substantially rigid portion;
said biased portion in contact with a tang portion of said folding knife to provide a biasing force on a blade of said folding knife.

12. The locking member of claim 11, wherein said biased member comprises a distal end having a protrusion for communicating with a tang of a blade of a folding knife.

13. The locking member of claim 11, wherein said biased member comprises a leaf spring.

14. The locking member of claim 11, wherein the locking member is affixed to at least one scale portion of a folding knife.

15. The locking member of claim 14, wherein a tang of said folding knife comprises a notch portion, said notch portion receiving at least a portion of said biased member such that a closing action of said blade requires a greater force than an opening action.

16. The locking member of claim 14, wherein said biased portion biases a blade portion of said knife toward a closed position at least when said blade is disposed between approximately zero degrees of rotation of approximately 30 degrees of rotation from said closed position.

17. The locking member of claim 11, wherein said biased member comprises an extension of said spacer.

18. The locking member of claim 14, wherein a tang portion of a blade portion of said knife comprises a radius of curvature for communicating with said biased member throughout rotation of said blade.

19. The locking member of claim 14, wherein said locking member is secured between a first scale and second scale by at least one fastener and said locking member comprises a length substantially less than a length of said scale portions.

20. The locking member of claim 11, wherein said biasing force impedes at least one of an opening and a closing of said blade.

21. A folding knife comprising:
a blade having an upper edge, a lower edge, a tang and a distal end;
a handle portion comprising first scale and a second scale, said first scale and said second scale comprising a forward end, a rear end, an upper end and a lower end;
said first scale and said second scale spaced apart by a predetermined width;
said tang of said blade rotatably interconnected to said handle portion;
a locking member disposed between respective interior surfaces of said first scale and said second scale, said locking member comprising an upper arm and a deflectable lower arm separated by a predetermined distance, and wherein the lower arm is in contact with said tang to provide a biasing force on said blade and secure the blade in at least one of an open and a closed position.
